(19) United States
(12) Patent Application Publication
(10) Pub. No.: US 2020/0150057 A1
(43) Pub. Date: May 14, 2020

(54) SYSTEMS AND METHODS FOR AUTOMATED EVALUATION OF GLASS-BASED SUBSTRATES FOR BIREFRINGENCE DEFECTS

(71) Applicant: CORNING INCORPORATED, CORNING, NY (US)

(72) Inventors: Raymond Geroe Greene, Ithaca, NY (US); Tomohiro Ishikawa, Corning, NY (US); Rohit Rai, Painted Post, NY (US); Seungcheol Yang, Horseheads, NY (US)

(21) Appl. No.: 16/683,359

(22) Filed: Nov. 14, 2019

Related U.S. Application Data
(60) Provisional application No. 62/767,217, filed on Nov. 14, 2018.

(51) Int. Cl. G01N 21/958; G01M 11/02; G01N 21/88

(52) U.S. Cl. CPC G01N 21/958; G01M 11/0278; G01N 2021/8848; G01N 21/8806; G01M 11/0257

(57) ABSTRACT

Systems and methods for evaluating glass-based substrates for birefringence defects are disclosed. In a one embodiment, a method includes generating an image of the at least one glass-based substrate, and determining at least one transmission curve, wherein the transmission curve plots transmission values versus position along the at least one line. The method further includes determining a defect metric from the at least one transmission curve. The method also includes comparing the defect metric to at least one standard.

This application claims the benefit of priority under 35 U.S.C. § 119 of U.S. Provisional Application Ser. No. 62/791,976 filed on Jan. 14, 2019 and U.S. Provisional Application Ser. No. 62/767,217 filed on Nov. 14, 2018, the content of which is relied upon and incorporated herein by reference in its entirety.

### BACKGROUND

### Field

The present disclosure generally relates to evaluation of glass-based substrates for transmission intensity variation defects and, more particularly, systems and methods for automated evaluation of glass-based substrates for birefringence defects.

### Technical Background

Glass-based substrates, such as glass substrates or glass ceramic substrates, may be utilized in a wide variety of applications. For example, glass-based substrates may be used as a cover glass in electronic devices, such as smartphones and tablets. These electronic devices are typically backlit by a linearly, quasi-linearly, circularly, and quasi-circularly polarized backlight.

The fabrication process of glass-based substrates used in electronic devices may have a non-uniform thermal profile that causes localized residual stress or birefringence that appears within the glass-based substrate. Such cover glass articles used in electronic devices such as smartphones, tablet, and TVs should have spatially uniform light transmission to have a high-quality user experience. Spatially non-uniform transmission of polarized light when the glass article is placed between a source of polarized light, such as from a smartphone or tablet, and an optical polarizer (e.g., sunglasses) can arise from any spatial variation of stresses in the cover glass article. Thus, birefringence defects may be visible to a user of an electronic device, particularly in a crossed polarizer situation, such as where a user is wearing polarized sunglasses. One or more defect regions may be visible to the user, such as near an edge of the glass-based substrate.

In an example, glass-based substrates may be formed by a rolling process. The rolling process has several advantages regarding the range of glass compositions it can make, but the contact nature of forming using rollers and conveyors may lead to difficulties in thermal control of the part. Particularly, a rolling fabrication may produce residual stresses in the glass article that are spatially non-uniform in magnitude and orientation of the principal stresses. The substantially vertical (i.e., long axis of the cover glass article) banded stress patterns in the rolled glass produce defects are substantially vertical bands of intensity variations. These defects may be undesirable.

During production, these defects are typically detected through human eye operator grading inspection of each cover glass part prior to its assembly in an electronic device (e.g., grades A, B, C, D, and F). However, such a method is very subjective. Grading of defects may vary from inspector to inspector, and, even for the same inspector, with the level of fatigue. Another disadvantage of such manual inspection is that it is time consuming and throughput is limited. Another disadvantage of such a qualitative system is that its fundamentally non-quantitative nature makes it difficult to use for process control and improvement.

### SUMMARY

In a first embodiment, a method of evaluating at least one glass-based substrate includes generating a transmission image of the at least one glass-based substrate, and determining at least one transmission curve along at least one line extending from a first edge of the transmission image to a second edge of the transmission image, wherein the transmission curve plots transmission values versus position along the at least one line. The method further includes determining a defect metric from the at least one transmission curve. The method also includes comparing the defect metric to at least one standard, and rejecting the at least one glass-based substrate when the defect metric does not satisfy the at least one standard.

In a second embodiment, the method of the first embodiment, wherein the defect metric is defined by a defect height divided by a defect width. The width is a distance between a first point of interest and a second point of interest based on the at least one transmission curve. The height is a distance between an extreme point and a line between the first point of interest and the second point of interest.

In a third embodiment, the method of the second embodiment, wherein the determining of the defect metric further includes determining a first derivative of the at least one transmission curve, the first point of interest is a first inflection point determined by a first position on the first derivative of the at least one transmission curve having a minimum value, and the second point of interest is a second inflection point determined by a second position on the first derivative of the at least one transmission curve having a maximum value.

In a fourth embodiment, the method of the third embodiment, further including causing for display a first derivative image representing the first derivative of the at least one transmission curve.

In a fifth embodiment, the method of the fourth embodiment, wherein the determining of the defect metric further includes determining a second derivative of the at least one transmission curve, the first point of interest is a first inflection point determined by a first position where the second derivative of the at least one transmission curve crosses a zero axis, the second point of interest is a second inflection point determined by a second position where the second derivative of the at least one transmission curve crosses the zero axis, and the first inflection point and the second inflection point are located on opposing sides of the extreme point.

In a sixth embodiment, the method of the fifth embodiment, further including causing for display a second derivative image representing the second derivative of the at least one transmission curve.

In a seventh embodiment, the method of the second embodiment, wherein the first point of interest is defined by a first maximum transmission value when the extreme point is a point of minimum transmission or a first minimum transmission value when the extreme point is a point of maximum transmission, the second point of interest is defined by a second maximum transmission value when the extreme point is a point of minimum transmission or a second minimum transmission value when the extreme point is a point of maximum transmission, the first point of interest and the second point of interest are located on opposing sides of the extreme point, and the first inflection point and the second inflection point are located on opposing sides of the extreme point.

In an eighth embodiment, the method of any preceding embodiment, wherein the transmission image of the at least one glass-based substrate is generated by taking a first image of the at least one glass-based substrate and a second image of a background without the at least one glass-based substrate, and subtracting the second image from the first image.

In an ninth embodiment, the method of any preceding embodiment, wherein the generating of the transmission image further include backlighting the at least one glass-based substrate.

In a tenth embodiment, the method of the ninth embodiment, wherein the generating of the transmission image further includes propagating light from a backlight through a first linear polarizer, through the at least one glass-based substrate, through a quarter waveplate, and through a second linear polarizer.

In an eleventh embodiment, the method of tenth embodiment, wherein a transmission axis of the first linear polarizer is 45 degrees clockwise, a fast axis of the quarter waveplate is 45 degrees counter-clockwise, and a transmission axis of the second linear polarizer is 45 degrees counter-clockwise plus an offset a.

In a twelfth embodiment, the method of any one of the first through seventh embodiments, wherein the transmission image is a calculated transmission image based at least in part on retardance data of the glass-based substrate.

In a thirteenth embodiment, the method of the twelfth embodiment, wherein the calculated transmission image is calculated by measuring a retardance at a plurality of locations of the glass-based substrate, and calculating, by a computing device, one or more transmission values at one or more locations of the plurality of locations of the glass-based substrate.

In a fourteenth embodiment, the method of the thirteenth embodiment, wherein the plurality of locations is a plurality of (x, y) locations across an entire area of the glass-based substrate.

In a fifteenth embodiment, the method of the fourteenth embodiment, wherein the one or more transmission values are calculated for each (x, y) location of the plurality of (x, y) locations.

In a sixteenth embodiment, the method of any one of the thirteenth through fifteenth embodiments, wherein the one or more transmission values are calculated for each (x, y) location of the plurality of (x, y) locations.

In a seventeenth embodiment, the method of the sixteenth embodiment, wherein the one or more transmission values are calculated based at least in part on a characterization of an optical set-up.

In an eighteenth embodiment, the method of the seventeenth embodiment, wherein a transmission value for each location of the plurality of locations is defined by: Tₛₘ(x, y)=[Analyzerₛₘ·Waveplateₛₘ·Substrate(R, θ, x, y)·Stokesₛₘ][1], where: Analyzerₛₘ is a Mueller matrix of an ideal linear polarizer with a given transmission axis value, Waveplateₛₘ is a Mueller matrix of a retarder with a given magnitude and fast axis, Substrate(R, θ, x, y) is a Mueller matrix for a retarder with measured retardance at location (x, y), wherein the retardance includes a retardance magnitude R and a retardance azimuth θ, Stokesₛₘ is the Stokes vector for polarized light at a predetermined angle, and [1] denotes the 1st element of the vector.

In a nineteenth embodiment, the method of the thirteenth embodiment, wherein a transmission value for each location of the plurality of locations is defined by: Tₚₕₒₙₑ(x, y)=[Analyzer_{φ}·Substrate(R, θ, x, y)19 Stokesₚₕₒₙₑ][1], where Analyzerₒ is a Mueller of a linear polarizer with respect to an electronic device and the glass-based substrate, Substrate(R, θ, x, y) is a Mueller matrix for a retarder with measured retardance at location (x, y), wherein the retardance includes a retardance magnitude R and a retardance azimuth θ, Stokesₚₕₒₙₑ is the Stokes vector for polarized light at a predetermined angle, and [1] denotes the 1st element of the vector.

In a twentieth embodiment, the method of any preceding embodiment, wherein the at least one transmission curve includes a plurality of transmission curves, and the plurality of transmission curves are determined along a plurality of lines extending from the first edge to the second edge of the transmission image.

In a twenty-first embodiment, the method of the twentieth embodiment, wherein the at least one transmission curve is an average of the plurality of transmission curves.

In a twenty-second embodiment, the method of any one of the first through eleventh, twentieth and twenty-first embodiments, wherein the at least one glass-based substrate includes a plurality of glass-based substrates, and the method further includes stacking the plurality of glass-based substrates prior to generating the transmission image of the at least one glass-based substrate.

In a twenty-third embodiment, the method of the twenty-second embodiment, wherein the plurality of glass-based substrates is separated from a glass-based sheet.

In a twenty-fourth embodiment, the method of the twenty-third embodiment, wherein the plurality of glass-based substrates share a common edge of the glass-based sheet.

In a twenty-fifth embodiment, the method of the twenty-third embodiment, wherein the plurality of glass-based substrates are within a common column of the glass-based sheet.

In a twenty-sixth embodiment, a system for evaluating at least one glass-based substrate includes one or more processors, and a computer-readable medium storing computer-executable instructions that, when executed by the one or more processors, cause the one or more processors to generate a transmission image of the at least one glass-based substrate, and determine at least one transmission curve along at least one line extending from a first edge of the transmission image to a second edge of the transmission image, wherein the transmission curve plots transmission values versus position along the at least one line. The computer-executable instructions further cause the processor to compare the defect metric to at least one standard.

In a twenty-seventh embodiment, the system of the twenty-sixth embodiment, wherein the computer-executable instructions further cause the processor to determine a defect metric from the at least one transmission curve, and the defect metric is defined by a defect height divided by a defect width. The width is a distance between a first point of interest and a second point of interest based on the at least one transmission curve. The height is a distance between an extreme point and a line between the first point of interest and the second point of interest.

In a twenty-eighth embodiment, the system of the twenty-seventh embodiment, wherein the defect metric is determined by determining a first derivative of the at least one transmission curve, the first point of interest is a first inflection point determined by a first position on the first derivative of the at least one transmission curve having a minimum value, the second point of interest is a second inflection point determined by a second position on the first derivative of the at least one transmission curve having a maximum value, and the first inflection point and the second inflection point are located on opposing sides of the extreme point.

In a twenty-ninth embodiment, the system of the twenty-eighth embodiment, wherein the computer-executable instructions further cause the one or more processors to provide for display a first derivative image representing the first derivative of the at least one transmission curve.

In a thirtieth embodiment, the system of the twenty-seventh embodiment, wherein the defect metric further is determined by determining a second derivative of the at least one transmission curve, the first point of interest is a first inflection point determined by a first position where the second derivative of the at least one transmission curve crosses a zero axis, the second point of interest is a second inflection point determined by a second position where the second derivative of the at least one transmission curve crosses the zero axis, and the first inflection point and the second inflection point are located on opposing sides of the extreme point.

In a thirty-first embodiment, the system of the thirtieth embodiment, wherein the computer-executable instructions further cause the one or more processors to prepare for display a second derivative image representing the second derivative of the at least one transmission curve.

In a thirty-second embodiment, the system of the seventeenth embodiment, wherein the first point of interest is defined by a first maximum transmission value, the second point of interest is defined by a second maximum transmission value, and the first point of interest and the second point of interest are located on opposing sides of the extreme point.

In a thirty-third embodiment, the system of any one of the twenty-second through thirty-second embodiments, wherein the transmission image of the at least one glass-based substrate is generated by taking a first image of the at least one glass-based substrate and a second image of a background without the at least one glass-based substrate, and subtracting the second image from the first image.

In a thirty-fourth embodiment, the system of any one of the twenty-seventh through thirty-second embodiments, wherein the system further comprises a backlight for backlighting the at least one glass-based substrate.

In a thirty-fifth embodiment, the system of the thirty-fourth embodiment, wherein the system further comprises a first linear polarizer, a quarter waveplate, and a second linear polarizer.

In a thirty-sixth embodiment, the system of the thirty-fifth embodiment, wherein a transmission axis of the first linear polarizer is 45 degrees clockwise, a fast axis of the quarter waveplate is 45 degrees counter-clockwise, and a transmission axis of the second linear polarizer is 45 degrees counter-clockwise plus an offset α.

In a thirty-seventh embodiment, the system of any one of the twenty-seventh through thirty second embodiments, wherein the transmission image is a calculated transmission image based at least in part on retardance data of the glass-based substrate.

In a thirty-eighth embodiment, the system of the thirty-seventh embodiment, wherein the calculated transmission image is calculated by measuring a retardance at a plurality of locations of the glass-based substrate, and calculating, by a computing device, one or more transmission values at one or more locations of the plurality of locations of the glass-based substrate.

In a thirty-ninth embodiment, the system of the thirty-ninth embodiment, wherein the plurality of locations is a plurality of (x, y) locations across an entire area of the glass-based substrate.

In a fortieth embodiment, the system of the thirty-ninth embodiment, wherein the one or more transmission values are calculated for each (x, y) location of the plurality of (x, y) locations.

In a forty-first embodiment, the system of any one of the thirty-eighth through fortieth embodiments, wherein the one or more transmission values are calculated for each (x, y) location of the plurality of (x, y) locations.

In a forty-second embodiment, the system of the forty-first embodiment, wherein the one or more transmission values are calculated based at least in part on a characterization of an optical set-up.

In a forty-third embodiment, the system of the forty-second embodiment, wherein a transmission value for each location of the plurality of locations is defined by: Tₛₘ(x, y)=[Analyzerₛₘ·Waveplateₛₘ·Substrate(R, θ, x, y)·Stokesₛₘ][1], where: Analyzerₛₘ is a Mueller matrix of an ideal linear polarizer with a given transmission axis value, Waveplateₛₘ is a Mueller matrix of a retarder with a given magnitude and fast axis, Substrate(R, θ, x, y) is a Mueller matrix for a retarder with measured retardance at location (x, y), wherein the retardance includes a retardance magnitude R and a retardance azimuth θ, Stokesₛₘ is the Stokes vector for polarized light at a predetermined angle, and [1] denotes the 1st element of the vector.

In a forty-forth embodiment, the system of the thirty-eighth embodiment, wherein a transmission value for each location of the plurality of locations is defined by: Tₚₕₒₙₑ(x, y)=[Analyzer_{φ}·Substrate(R, θ, x, y)·Stokesₚₕₒₙₑ][1], where Analyzer_{φ} is a Mueller matrix of a phone, linear polarizer with respect to an electronic device and the glass-based substrate, Substrate(R, θ, x, y) is a Mueller matrix for a retarder with measured retardance at location (x, y), wherein the retardance includes a retardance magnitude R and a retardance azimuth θ, Stokesₚₕₒₙₑ is the Stokes vector for polarized light at a predetermined angle, and [1] denotes the 1st element of the vector.

In a forty-fifth embodiment, the system of any one of the twenty-seventh through forty-forth embodiments, wherein the at least one transmission curve comprises a plurality of transmission curves, and the plurality of transmission curves are determined along a plurality of lines extending from the first edge to the second edge of the transmission image.

In a forty-sixth embodiment, the system of the forty-fifth embodiment, wherein the at least one transmission curve includes an average of the plurality of transmission curves.

In a forty-seventh embodiment, the system of any one of the twenty-seventh through 36, forty-fifth, and forty-sixth embodiments, wherein the at least one glass-based substrate includes a plurality of glass-based substrates in a stacked arrangement.

In a forty-eighth embodiment, the system of the forty-seventh embodiment, wherein the plurality of glass-based substrates is separated from a glass-based sheet.

In a forty-ninth embodiment, the system of the forty-eighty embodiment, wherein the plurality of glass-based substrates share a common edge of the glass-based sheet.

In a fiftieth embodiment, the system of the forty-eighth embodiment, wherein the plurality of glass-based substrates are within a common column of the glass-based sheet.

Additional features and advantages of the embodiments disclosed herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawings, where like structure is indicated with like reference numerals and in which:

FIG. 1 depicts digital images of example non-strengthened glass substrates having birefringence defects prior to a thinning process;

FIG. 2 schematically depicts an example optical set-up for evaluating spatial defects in a glass-based substrate according to one or more embodiments described and illustrated herein;

FIG. 3A depicts a digital image of a portion of the glass-based substrate having a birefringence defect;

FIG. 3B depicts a digital image from an optical setup without a glass-based substrate to serve as a background image;

FIG. 3C depicts a digital image that is the digital image of FIG. 3A subtracted by the background image of FIG. 3C according to one or more embodiments described and illustrated herein;

FIG. 3D depicts a digital image showing the detection of defect boundaries as the locations based on the first principal curvature sign change according to one or more embodiments described and illustrated herein;

FIG. 3E depicts a digital image having a high curvature region highlighted according to one or more embodiments described and illustrated herein;

FIG. 4A depicts a digital image of a glass-based substrate having a birefringent defect and a cross-sectional transmission profile graph of the digital image according to one or more embodiments described and illustrated herein;

FIG. 4B depicts a digital image and a cross-sectional transmission profile graph of the first derivative of the digital image of FIG. 4A according to one or more embodiments described and illustrated herein;

FIG. 4C depicts a digital image and a cross-sectional transmission profile graph of the second derivative of the digital image of FIG. 4A according to one or more embodiments described and illustrated herein;

FIG. 5 depicts the cross-sectional transmission profile graphs of FIGS. 4A-4C according to one or more embodiments described and illustrated herein;

FIG. 6 graphically depicts an example calculation of a defect metric according to one or more embodiments described and illustrated herein;

FIG. 7A depicts a digital image of a glass-based substrate having a birefringence defect and vertical lines showing boundaries of defect metric measurements according to one or more embodiments described and illustrated herein;

FIG. 7B graphically depicts an example calculation of a defect metric according to one or more embodiments described and illustrated herein;

FIG. 8 graphically depicts a plurality of glass-based articles within a glass-based sheet according to one or more embodiments described and illustrated herein;

FIG. 9 depicts a flowchart of an example process of determining a defect metric of a glass-based substrate according to one or more embodiments described and illustrated herein;

FIG. 10A depicts a retardance magnitude map of a sample according to one or more embodiments described and illustrated herein;

FIG. 10B depicts a retardance magnitude map of another sample according to one or more embodiments described and illustrated herein;

FIG. 11A depicts a retardance azimuth map of the sample of FIG. 10A according to one or more embodiments described and illustrated herein;

FIG. 11B depicts a retardance azimuth map of the sample of FIG. 10B according to one or more embodiments described and illustrated herein;

FIG. 12A depicts a transmission map of transmission values calculated for the sample of FIGS. 10A and 11A according to one or more embodiments described and illustrated herein;

FIG. 12B depicts a transmission map of transmission values calculated for the sample of FIGS. 10B and 11B according to one or more embodiments described and illustrated herein;

FIG. 13 graphically depicts measured retardance magnitude and azimuth for a cross section of a glass substrate according to one or more embodiments described and illustrated herein;

FIG. 14 depicts transmission map images of a smartphone having four sample glass substrate covers viewed through polarizers at various angles from measured retardance and azimuth according to one or more embodiments described and illustrated herein;

FIG. 15 graphically depicts a flowchart of an example process for quantitatively evaluating a glass-based substrate for transmission intensity variation defects according to one or more embodiments described and illustrated herein; and

FIG. 16 depicts a computer system for evaluating a glass-based substrate for birefringence defect according to one or more embodiments described and illustrated herein;

### DETAILED DESCRIPTION

Referring generally to the figures, embodiments of the present disclosure are directed to automated vision inspection systems and methods for estimating birefringence defects using a quantification method. Embodiments described herein identify the birefringence patterns by processing sample images at the optical setup used to image the glass-based samples. The optical setup is a polarized imaging system that may include, but is not limited to, a spatial stress birefringence measurement system, a polarized light microscope, or a polariscope. Generally, the optical setup provides spatial intensity differences according to stress patterns within glass-based substrates (i.e., birefringence defects).

Retardance is an integrated effect of the birefringence defect acting along the path of a light beam that traverses the glass-based substrate. When the incident light beam is linearly polarized, the two orthogonal components of the polarized light will exit the sample with a phase difference referred to as retardance. Birefringence defects appear as darker/brighter segments in the image of the optical setup based on the sample.

Cover glass articles for the front of electronic display devices such as smartphones, tablets, and TVs should have spatially uniform light transmission to provide the highest quality of user experience. Spatially non-uniform transmission of polarized light when the glass article is placed between a source of polarized light, such as a smartphone or tablet, and an optical polarizer (e.g. sunglasses) can arise from any spatial variation of stresses in the cover glass article. For example, glass sheets used to manufacture cover glass parts by a rolling process have residual stresses that are spatially non-uniform in magnitude and orientation of the principal stresses. The linear banded stress patterns in the glass may produce birefringent defects (e.g., linear bands of intensity variations when viewed through an optical polarizer) that may be undesirable to some. Additional information regarding birefringent defects and methods for reduction of birefringent defects is provided in U.S. Pat. Appl. No. 62/747,787, filed Oct. 19, 2018, which is hereby incorporated by reference in its entirety.

These defects are typically detected through human-eye operator grading inspection of each cover glass part prior to its assembly in a smartphone (e.g., grade A, B, C, D, or F). In one example, each finalized part (i.e., parts that have been thinned/polished and/or strengthened by a strengthening process) is placed in a suitably designed and heuristically configured optical setup, such as a polarizing stress meter. An example polarizing stress meter is the PSV590, sold by Suzhou PTC Optical Instrument Co. Ltd. of China. The optical design and configuration of the inspection system produces and manipulates the quasi-normal incident polarization state of the light into and out of the sample to maximize the visibility of the band.

Embodiments of the present disclosure are directed to systems and methods of measuring birefringence defects of glass-based substrates and quantifying the glass-based substrates based on a defect metric to either accept or reject the glass-based substrates. The pattern of the birefringence defect is a smooth and gradual change in the low frequency range. The change can be represented by the image curvature. The first and/or second derivative of the image profile allows the birefringence defect to be characterized as well as allows for the level of contrast to be determined.

In embodiments, the image curvature change is calculated by the first principal curvature off the image and represents the change of intensity gradient that can be detected by the human eye. Due to the characteristics of a glass rolling process, the stress band of the birefringence defect is generated in a 1D band shape along the direction of the rolling process. Therefore, the first and second derivative of the image profile only relies on 1D profile data along the direction of the rolling process. The profile is an average of the sample image in a direction perpendicular to the rolling process.

The first and/or second derivative information is used to define local maximum points (or minimum points) and nearby inflection points, which are points of interest used to define a defect metric. A ratio of the image intensity change between a local maximum (or minimum) point and two inflection points to the distance between the two inflection points is one non-limiting example of a defect metric.

Various embodiments of systems and methods for quantifiably evaluating glass-based substrates for birefringence defects using a defect metric are described in detail below.

As used herein, the term “glass-based substrate” includes glass materials and glass-ceramic materials. In some embodiments, the glass-based substrate does not include lithium. As a non-limiting example, the glass-based substrate is an alkali-aluminosilicate glass material.

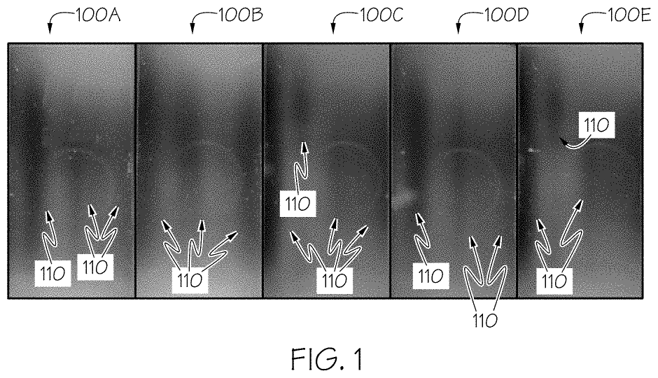

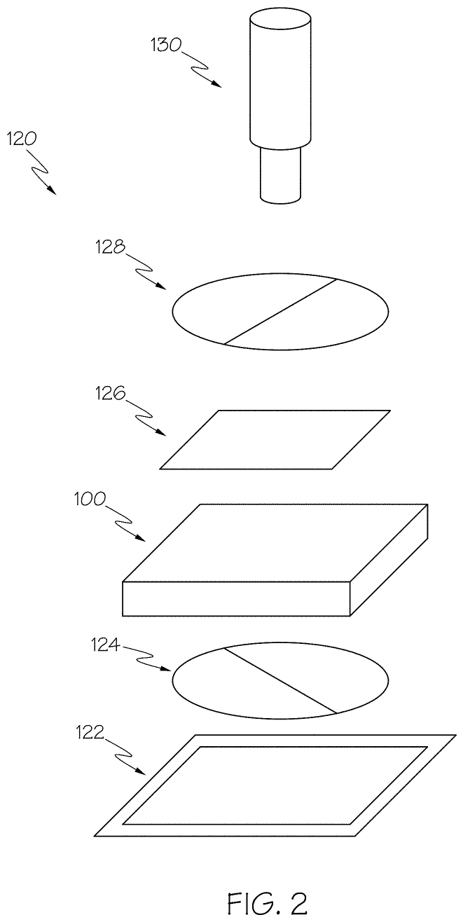

FIG. 1 show digital images 100A-100E of intensity variations through five 1.1 mm thick alkali-aluminosilicate glass substrates following a rolling process as viewed through a PSV590 polarizing stress meter optical set-up as schematically depicted by FIG. 2 and described below. The intensity variations produce noticeable linear birefringence defects 110 parallel to the travel direction of the rolling process used to form the glass substrates. The fast cooling rates and contact nature of a rolling process to form thin glass-based sheets (e.g., thickness less than 5 mm) lead to some residual stresses that produce the birefringence defects. The birefringence defects 110 shown in FIG. 1A may be undesirable, particularly when viewed through a polarizer such as polarized sunglasses.

It is noted that some of the intensity variations in FIG. 1 are due to reflections from the surroundings. The visible circular patterns in FIG. 1 are from the optical set-up itself. In some cases, a reflection of the camera and a hand holding the camera is visible. These intensity variations are not stress induced defects.

The appearance of the birefringence defects changes after subsequent processing steps. In most cases, an intensity level actually decreases following subsequent processing steps.

FIG. 2 schematically depicts the optical set-up 120 used to produce the example images of transmission intensity variations in glass-based substrates disclosed herein. Particularly, FIG. 2 illustrates the sequence of optical elements in the PSV590 system. It should be understood that embodiments are not limited to the PSV590 system or the particular optical set-up 120 depicted by FIG. 2. The optical set-up 120 comprises a light source 122 (a yellow light source (wavelength=590 nm, luminance=120 cd/m²) in this example) followed by a fixed linear polarizer 124 that has plane of polarization oriented +45 deg angle to the y axis. (Y-axis is the line joining the 0 and 180 deg marks on the top of the dial of the PSV590, +45 is in the clock-wise direction). The sample glass-based substrate 100 under test is placed after the fixed linear polarizer 124, which is then followed by a quarter-waveplate 126 (retardance=138 nm for 590 nm wavelength light source in this example) with its fast axis oriented along −45 deg. Embodiments are not limited to a quarter-waveplate as a half-waveplate may be utilized. Finally, there is a rotating linear polarizer 128, which is crossed with the fixed polarizer at dial positions of 0 or 180 deg. For the images of FIG. 1, the dial was set at 175 deg to maximize the ability of the system to detect the defects. The glass-based substrate 100 under test may be viewed by an imaging system 130 (e.g., a digital camera). The imaging system 130 produces digital images that are used to evaluate the glass-based substrates 100.

The PSV590 optical set-up 120 described above and shown in FIG. 2 is just an example of an optical set-up that can be used to detect stress birefringence defects in glass-based substrates. Other configurations are possible as well. For example, the angle of the rotating linear polarizer 128 could be different than as described above. In other variations, the light source 122 could be monochromatic with a different wavelength, or the light source 122 could have a continuous wavelength spectrum (e.g. white light). As another non-limiting example, the PSV413 system sold by Suzhou PTC Optical Instrument Co. Ltd. has a white light source.

Further, yet another detection system could have a quarter-waveplate 126 between the fixed linear polarizer 124 and the glass-based substrate 100 at an angle of 45 deg with respect to the fixed linear polarizer 124, creating circularly polarized light that passed first through the glass-based substrate 100 under test and then through the rotating linear polarizer 128. Another detection system could have the test sample placed between two linear polarizers.

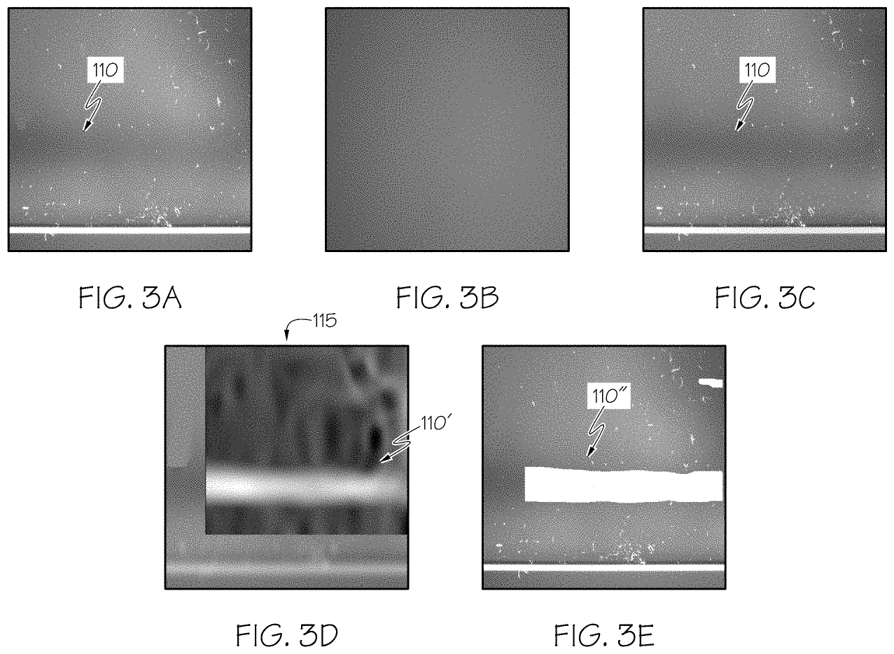

FIG. 3A is a digital image of a portion of a glass-based substrate 100 having a birefringent defect 110 taken with the optical setup 120 shown in FIG. 2. FIG. 3B is another digital image taken with the optical setup 120 of FIG. 2 without a glass-based substrate 100. The image of FIG. 3B may optionally serve as a background image that is subtracted from the image of FIG. 3A as shown in the resulting digital image of FIG. 3C. This background subtraction method is an image processing technique that is used to remove unwanted ambient light. However, it should be understood that background subtraction may not be utilized in other embodiments.

FIG. 3D is a digital image showing the detection of defect boundaries as the locations based on the first principal curvature sign change (i.e., the locations where the first principal curvature crosses zero). Input images are narrowed down to a region of interest 115 and the main principal curvature of the image is calculated as shown in FIG. 3D, showing defect region 110′. Each x, y location of the image has a transmission value (e.g., 0-255). The transmission values are used to calculate the main principal curvature of the digital image. The high curvature region 110″ is highlighted and segmented with a thresholding method (FIG. 3E).

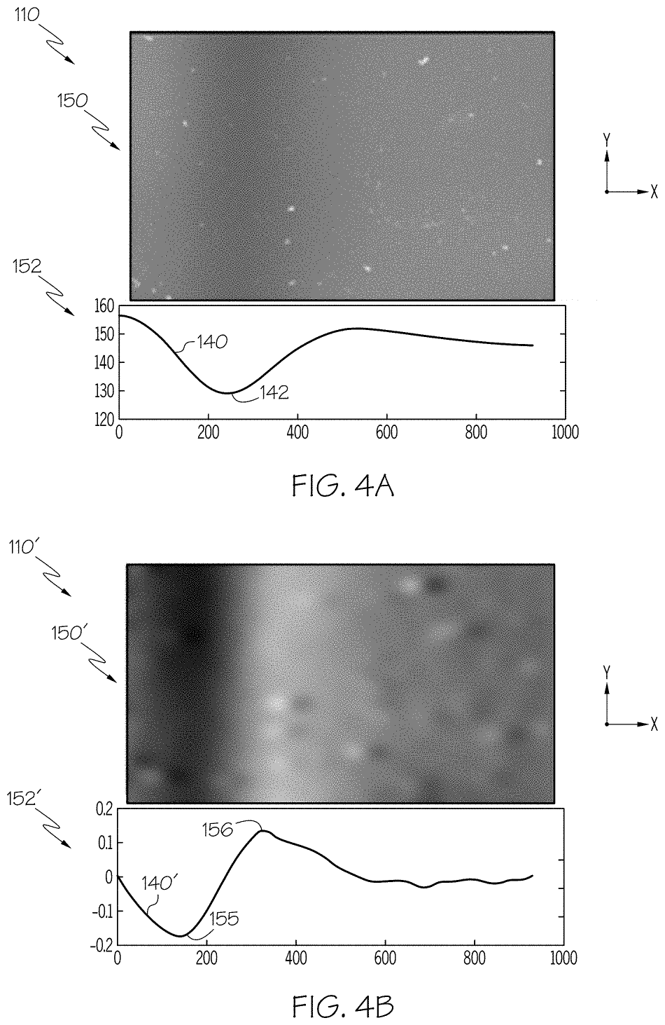

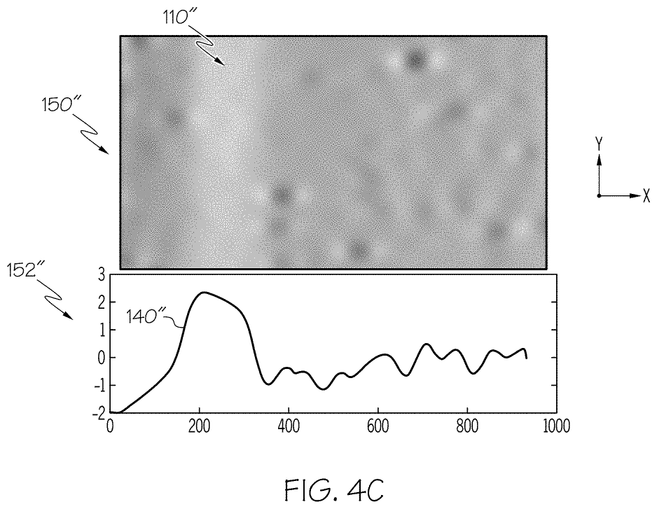

FIGS. 4A-4C illustrate an example process for calculating a defect method using a cross-sectional profile of a transmission image and its first or second derivative. FIG. 4A depicts a digital image 150 of a glass-based substrate having a birefringent defect 110 as a vertical band in the direction of a rolling process (i.e., along the y-axis). FIG. 4A also depicts a cross-sectional transmission profile graph 152 of the digital image 150 in a direction perpendicular to the rolling direction (i.e., along the x-axis). The cross-sectional transmission profile graph 152 includes a transmission curve 140 that plots transmission values in the y-axis along the x-axis of the glass-based substrate 100. As a non-limiting example, the transmission values may be in a range of 0-255, where 0 is a transmission value of lowest intensity and 255 is a transmission value of highest intensity. It is noted that the transmission curve 140 may be based on transmission values along a single cross-section of the image (i.e., a single line from a first edge to a second edge of the image), or an average of several cross-sections of the image. The example transmission curve 140 of FIG. 4A has a minimum transmission value 142 (i.e., a minimum point) where the image is darkest. In the example, the minimum transmission value 142 occurs at approximately 250 mm along the x-axis. This is an extreme point 142. It is noted that the birefringence defect 110 may appear light instead of dark as shown in FIG. 4A depending on the orientation of the glass-based substrate in the optical setup 120. In such case, the maximum transmission value may be determined rather than a minimum transmission value. Thus, the extreme point may be a maximum transmission value rather than a minimum transmission value depending on the orientation of the glass-based substrate.

FIG. 4B shows an image 150′ of the first derivative of the digital image of FIG. 4A. The first derivative was processed with the vertical directional Gaussian derivative function. Additional information regarding Gaussian derivative function is found at Young, Richard A., Ronald M. Lesperance, and W. Weston Meyer. “The Gaussian derivative model for spatial-temporal vision: I. Cortical model.” Spatial vision 14.3 (2001): 261-319, and Gaussian derivatives. In: Front-End Vision and Multi-Scale Image Analysis. Computational Imaging and Vision, vol 27. Springer, Dordrecht (2003). Thus, the image is processed with a one directional Gaussian derivative method (i.e., perpendicular to the band pattern direction). FIG. 4B also illustrates a first derivative cross-sectional transmission profile graph 152′ along the same line (or average of lines) as FIG. 4A. The first derivative cross-sectional transmission profile graph 152′ includes a first derivative transmission curve 140′ having a minimum value 155 and a maximum value 156.

FIG. 4C shows an image 150″ of the second derivative of the digital image of FIG. 4A. The second derivative was processed with the vertical directional Gaussian derivative function. FIG. 4C also illustrates a second derivative cross-sectional transmission profile graph 152″ along the same line (or average of lines) as FIGS. 4A and 4B. The second derivative cross-sectional transmission profile graph 152″ includes a second derivative transmission curve 140″.

The embodiments described herein determine the defect metric by estimating two inflection points (i.e., points of interest) where the first principal curvature changes sign and an extreme point (either the minimum or the maximum) over the cross-sectional profile.

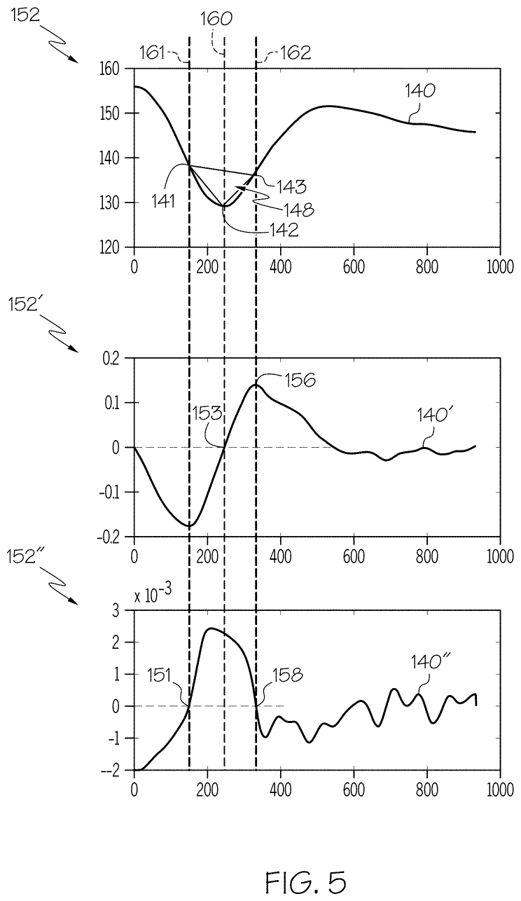

FIG. 5 shows the graphs 152, 152′, and 152″ of FIGS. 4A-4C aligned along the respective x-axes. Central vertical line 160 extends between the minimum point 142 and zero crossing point 153 of the first derivative transmission curve 140′. Zero crossing point 153 is where the first derivative transmission curve 140′ changes signs. Left vertical line 161 extends between a minimum point 155 of the first derivative transmission curve 140′ and a first zero crossing point 151 of the second derivative transmission curve 140″. Right vertical line 162 extends between a maximum point 156 of the first derivative transmission curve 140′ and a second zero-crossing of the second derivative transmission curve 140″.

First and second points of interest are determined. As an example, a first point of interest is a first inflection point 141 on the transmission curve 140 that is determined by the x-axis position of the first zero-crossing point (i.e., where the left vertical line 161 crosses the transmission curve 140). A second point of interest is a second inflection point 143 on the transmission curve 140 that is determined by the x-axis position of the second zero-crossing point (i.e., where the right vertical line 162 crosses the transmission curve 140). Alternatively, the first inflection point 141 may be determined by the x-axis position of the minimum point 155 on the first derivative transmission curve 140′, and the second inflection point 143 may be determined by the x-axis position of the maximum point 155 on the first derivative transmission curve 140′.

The first and second inflection points 141, 143 and the peak (i.e., minimum point 142) are used to calculate a defect metric. The defect metric may be calculated in a variety of ways. In one non-limiting example, the defect metric is from a height over width ratio defined by a triangle formed from first and second inflection points 141, 143 and the minimum point 142.

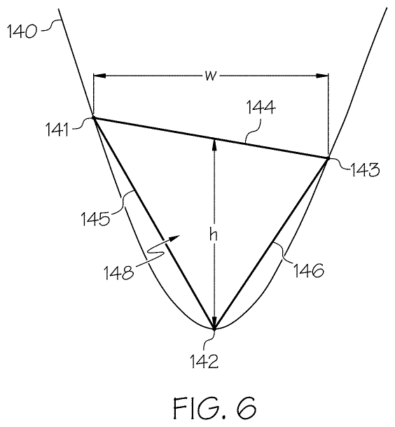

The transmission profile graph 152 of FIG. 5 shows a triangle 148 formed by the first and second inflection points 141, 143 and the minimum point 142 on the transmission curve 140. A close-up view of the triangle 148 on the transmission curve 140 is shown in FIG. 6. The triangle is defined by segment 145 between minimum point 142 and the first inflection point 141, segment 144 between the first inflection point 141 and the second inflection point 143, and segment 146 between the second inflection point 143 and the minimum point 142. The defect metric is calculated by a height h of the triangle 148 and a width w of the triangle 148. In the illustrated embodiment, the height h is determined by a vertical line from the minimum point 142 (or in some cases, a maximum point) to an intersection between the vertical line and segment 144. In other embodiments, the height h is determined by a distance along a line orthogonal to segment 144 from the minimum point 142 to the intersection between the line and segment 144. The width w is determined by the length of segment 144 (i.e., the distance between first inflection point 141 and the second inflection point 143).

Table 1 below includes defect metric values for defects of different intensity according to human eye inspection (A is lightest, and D is darkest). The metric unit is “intensity/pixel.”

TABLE 1

| | (A) | (B) | (C) | (D) |
|---|---|---|---|---|
| Defect Metric | 10.3 × e−3 | 19.6 × e−3 | 40.9 × e−3 | 42.4 × e−3 |

A threshold value (e.g., >40×e-3, or even more conservatively >20×e-3) may be used as a standard for rejection by the ratio of intensity difference over width between two inflection points. Thus, rather than rely on subjective human inspection, the evaluation process may be greatly improved by utilizing an automated objective defect metric method.

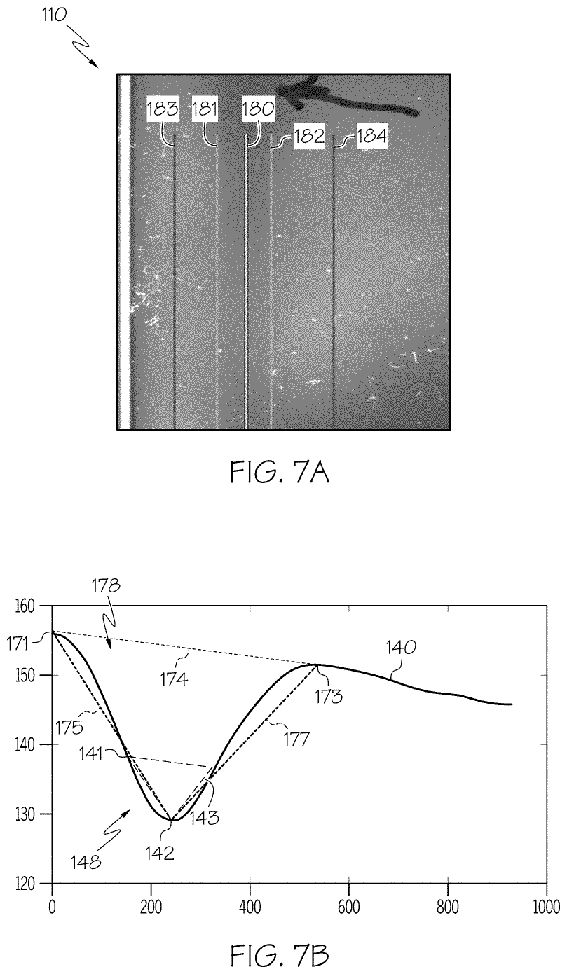

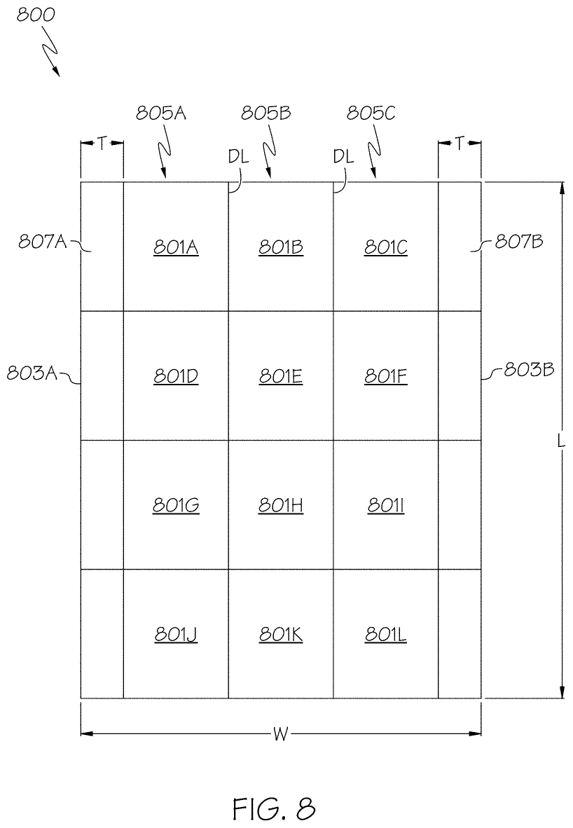

The defect metric may be determined in other ways in the embodiments described herein. As another example, the defect metric may be calculated using local maximum transmission values from the transmission curve 140 as shown in FIGS. 7A and 7B. FIG. 7A shows the digital image of FIG. 4A with line 180 showing the center line of the defect 110, lines 181 and 182 showing the positions of the inflection points 141, 143, respectively, and lines 183 and 184 showing the positions of local maximum transmission points 171, 173 of transmission curve 140 as first and second points of interest, respectively, as shown in FIG. 7B. Referring to FIG. 7B, the local maximum transmission points 171, 173 are on opposite sides of the minimum transmission value 142. A triangle 178 is formed by a tangent line connecting the local maximum transmission points 171, 173, segment 175 connecting minimum point 142 to local maximum point 171 (i.e., a first point of interest), and segment 177 connecting minimum point 142 to local maximum point 173 (i.e., a second point of interest). Thus, triangle 178 is larger than triangle 148; however, triangle 178 should produce a ratio of height h over width w similar to that of triangle 148. The defect metric may be calculated from triangle 178 in the same manner as from triangle 148.

Glass-based substrates used as cover glass in electronic devices often are chemically strengthened by an ion-exchange process. As the glass-based substrates are exposed to high temperature in the ion-exchange bath, glass-based substrates evaluated shortly after the ion-exchange process may have thermal gradients present. The thermal gradients may affect the stress profile within the glass-based substrates and therefore affect the defect metric. Table 2 compares the defect metric calculated for four samples at ambient temperature and at 40 deg C. The samples are the same as provided in Table 1 above.

TABLE 2

| | Sample 1 (A) | Sample 2 (B) | Sample 3 (C) | Sample 4 (D) |
|---|---|---|---|---|
| Defect Metric | 10.3 × e−3 | 19.6 × e−3 | 40.9 × e−3 | 42.4 × e−3 |
| (ambient) | | | | |
| Defect Metric | 3.3 × e−3 | 29.9 × e−3 | 34.5 × e−3 | 47.5 × e−3 |
| 40 deg C. | | | | |

Table 2 illustrates that the defect metric works even when small thermal gradients may be present in the glass-based substrate. Thus, even when transient stresses induced by thermal gradients are in the glass-based substrate when it is at a slightly elevated temperature, the impact to the defect metric is negligible. For example, thermal gradients may be present just after the rolling process. Thus, the methods described herein may be utilized online (i.e., on the rolling line) when some thermal gradients may be present when the glass-based substrate has not equilibrated to room temperature.

In some embodiments, a stack of multiple glass-based substrates may be simultaneously evaluated. Individual glass-based substrates may be separated from a mother sheet by a separation method following the rolling process. FIG. 8 schematically illustrates a top view of a glass-based sheet 800 having a width W and a length L. The sheet is formed by rolling a glass-based material in a direction parallel to the length L of the glass-based sheet 800 shown in FIG. 8. The sheet 800 will be later divided into a plurality of glass-based articles 801A-801L along dicing lines DL. Non-limiting dicing methods include mechanical separation by use of a scribing blade or by a laser process.

As shown in FIG. 8, a first quality area 807A is proximate a first edge 803A of the sheet 800 and a second quality area 807B is proximate a second edge 803B of the sheet 800. The first and second quality areas 807A, 807B are areas of the sheet 800 that are trimmed off of the sheet 800 to remove imperfections that may have resulted during the sheet fabrication process. For example, the handling of the sheet 800 may be performed in the first and second quality areas 807A, 807B, and such handling may create undesirable imperfections. Defects may also be due to edge effects. The first and second quality areas 807A, 807B may be trimmed off mechanically by a blade or by a laser process, for example.

The first and second quality areas 807A, 807B have a thickness T. Thus, when the sheet 800 is trimmed, it has a total width of W−2T. As a non-limiting example, the initial width W of the sheet 800 is 250 mm and the thickness of the first and second quality areas 807A, 807B is 10 mm each, thereby leaving a trimmed width of 230 mm after the trimming process. As another non-limiting example, the initial width W of the sheet 800 is 280 mm and the thickness T of the first and second quality areas 807A, 1107B is 25 mm, thereby leaving a trimmed width of 230 mm after the trimming process. It should be understood that the thickness of the first and second quality areas 807A, 807B may not be equal in some embodiments, or there may be no quality areas in some embodiments.

Stress within the sheet 800 may be present both proximate the edges as well as in the interior of the sheet 800 due to the rolling process as described above, or for other reasons. This stress may cause birefringence defects as described above. As stated above, the birefringence defects are presently vertically along the rolling direction (length L). Thus, birefringence defects may be present in multiple separated glass-based articles 801A-801L at similar x-axis locations. For example, one or more birefringence defects (not shown in FIG. 8) may vertically extend (i.e., along the length L of the glass-based sheet 800) across glass-based articles 801A, 801D, 801G, and 801J in a first common column 805A. Similarly one or more birefringence defects may vertically extend across glass-based articles 801B, 801E, 801H, and 801K in a second common column 805B, and one or more birefringence defects may vertically extend across glass based articles 801C, 801F, 8011, and 801L in a third common column 805C. The glass-based articles within respective columns share a common edge.

Because the birefringence defects are present at similar x-axis locations (i.e., along the width W of the glass-based sheet 800) of glass-based articles within respective columns 805A-805C may be stacked in the optical setup 120 and evaluated simultaneously. For example, glass-based articles 801A, 801D, 801G, and 801J may be stacked in the optical setup 120. The birefringence defects within the glass-based articles 801A, 801D, 801G, and 801J may be generally aligned and on top of one another. The stacked glass-based articles 801A, 801D, 801G, and 801J may cause the cumulative birefringence defects to be more visible due to increased contrast.

One or more defect metrics may be calculated for the stacked glass-based articles to increase evaluation throughput. If needed, individual glass-based articles (also referred to herein as glass-based substrates) may also be evaluated separately. In some embodiments, all of the glass-based articles of a glass-based sheet may be evaluated at one time such that the whole sheet may be quantified against one or more metrics.

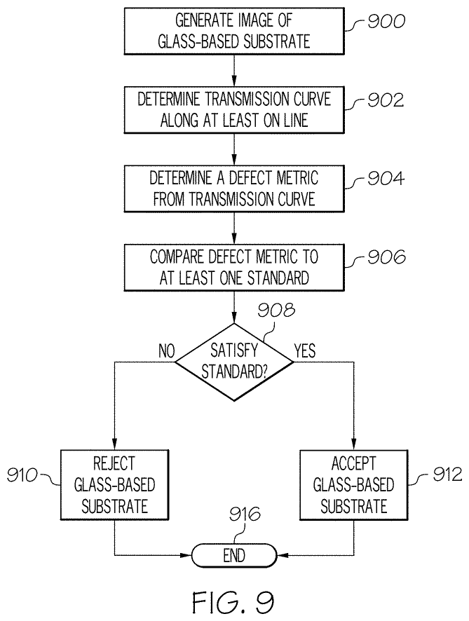

Referring now to FIG. 9, a flowchart of an example process for evaluating a glass-based substrate is illustrated. At block 900, an image of a glass-based substrate is generated by an optical setup. An example optical setup is provided in FIG. 2. The image is a polarized image of the glass-based substrate showing the presence of any birefringence defects. Next, at block 902, a transmission curve of transmission intensity values is determined along at least one line from a first edge of the image to a second edge of an image. The direction of the at least one line may be perpendicular to a rolling direction of the fabrication process of the glass-based substrate. The at least one line may be one cross-sectional line, or an average of a plurality of cross-sectional lines at different y-axis (i.e., the axis parallel to the rolling direction) locations.

A defect metric is determined from the transmission curve at block 904. In an example, the defect metric is defined by a defect height h divided by a defect width w. The width w is a distance between a first inflection point and a second inflection point of the at least one transmission curve, and the height h is a distance between an extreme point and an inflection line between the first inflection point and the second inflection point. At block 906, the defect metric is compared to at least one standard, such as a threshold. At block 908, it is determined whether or not the defect metric satisfies the at least one standard. If it does, the glass-based substrate may be accepted at block 912 and the process ends at block 916. If it does not, the glass-based substrate may be rejected at block 910 and the process ends at block 916.

The examples described above utilize transmission curves derived from transmission values of a transmission image at (x, y) locations as measured by an optical set-up, such as the optical set-up 120 (e.g., a PSV590 system) depicted by FIG. 2. However, embodiments are not limited thereto. As another example, transmission values at (x, y) locations of glass-based substrates may be derived from retardance data of glass-based substrates rather than by direct imaging methods using an optical setup. Deriving transmission values by not directly imaging the glass-based substrates may reduce image artifacts, such as glare, and may also increase manufacturing throughput because the glass-based substrates do not need to be separately imaged by the optical set-up.

More specifically, methods may model the optical set-up utilized to evaluate the glass-based substrates for transmission intensity variations such as birefringence defects described herein. The models characterize the optical set-up, and receive as inputs retardance data at a plurality of locations (i.e., (x, y) locations) of the glass-based substrate 100 under evaluation. The output of the models are transmission values T at the plurality of locations. The transmission values T may then be used to quantifiably characterize the glass-based substrate 100 by a defect metric to either accept or reject the glass-based substrate 100 as described above.

Retardance data at various locations of the glass-based substrate 100 are used as input into a model of one or more optical set-ups. Each retardance measurement of the retardance data has a retardance magnitude R and an azimuth θ. Retardance is an integrated effect of the birefringence defect acting along the path of a light beam that traverses the glass-based substrate. When the incident light beam is linearly polarized, the two orthogonal components of the polarized light will exit the sample with a phase difference referred to as retardance. Any method may be used to determine the retardance across the glass-based substrate 100. For example, the retardance of the glass-based substrate may be measured by a strain measurement system. As a non-limiting example, the retardance of glass-based substrates may be measured by the GFP1400 sold by Stress Photonics Inc. of Madison, Wis. Similar measurements may be made with other systems, such as commercially available systems (systems sold by Axometrics, Inc.) or custom-made systems.

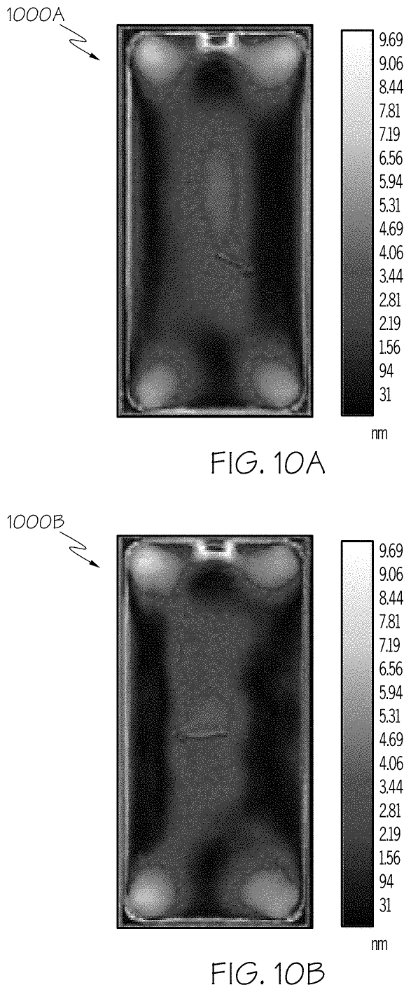

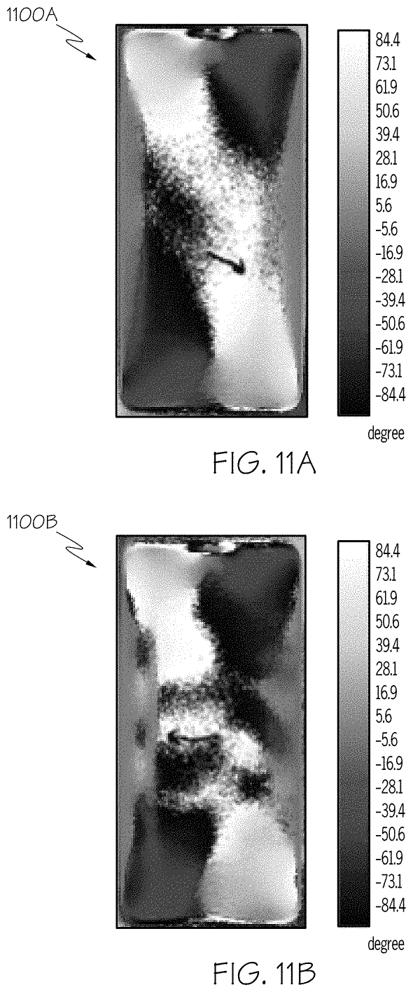

FIGS. 10A and 10B show images 1000A, 1000B depicting the retardance magnitudes R at locations across two different example glass substrates. FIGS. 11A and 11B show images 1100A, 1100B depicting the azimuth across the same two example glass substrates of the images 1000A, 1000B shown in FIGS. 10A and 10B. The measurements of the retardance data of FIGS. 10A, 10B, 11A and 11B were provide by the GFP1400 system.

The retardance data are used to create a transmission function, T(R, θ, x,y), where T is the transmission, R is the magnitude of retardance, and θ is the orientation of the fast axis of the cover glass part at location (x, y) (i.e., azimuth). The calculation of the transmission T values may be performed from the measured retardance of the glass-based substrate using the Mueller calculus where T is the first component of the Stokes vector, i.e. the total transmission. It should be noted that this same calculation can also be done using the Jones calculus or other formalisms for polarized light calculations. The coordinate system of the measured part is used herein: right handed coordinate system with x as the short axis, y as the long axis, 0° is along the positive x axis, 90° is along the positive y axis.

The transmission function is based on an optical set-up used to physically evaluate the glass-based substrate under test. In embodiments, the glass-based substrates may never be physically evaluated using an optical set-up, such as the optical set-up depicted by FIG. 2. In such embodiments, the glass-based substrates may only be evaluated using the measured retardance, the transmission values, and the defect metrics based on the transmission values.

An example transmission function for the PSV590 system is as follows:

Tₛₘ(x, y)=[Analyzerₛₘ·Waveplateₛₘ·Substrate(R, θ, x, y)·Stokesₛₘ][1], Eq. (1)

For the PSV590 configuration of FIG. 2, Stokesₛₘ is the Stokes vector of 45° linearly polarized light:

$${Stokes}_{sm} = [ \begin{matrix}1 \\ 0 \\ 1 \\ 0\end{matrix} ] , \qquad Eq . ( 2 )$$

Waveplateₛₘ is the Mueller matrix of a retarder with magnitude and fast axis with measured values for the optical set-up of FIG. 2:

$${Waveplate}_{sm} = [ \begin{matrix}1 & 0 & 0 & 0 \\ 0 & 0.100986 & 0 & 0.994887 \\ 0 & 0 & 1 & 0 \\ 0 & - 0.994887 & 0 & 0.1009868\end{matrix} ] , \qquad Eq . ( 3 )$$

Analyzerₛₘ is the Mueller matrix of a ideal linear polarizer with transmission axis value given in FIG. 2:

$${Analzer}_{PSV 590} = [ \begin{matrix}0.5 & 0.086824 & - 0.492404 & 0 \\ 0.086824 & 0.015076 & - 0.085505 & 0 \\ - 0.492404 & - 0.085505 & 0.484923 & 0 \\ 0 & 0 & 0 & 0\end{matrix} ] , \qquad Eq . ( 4 )$$

CoverGlass(R,θ,x,y) is the Mueller matrix for a retarder with the measured values of R, θ at location (x,y) of the cover glass part:

$$CoverGlass ( R , θ , x , y ) = [ \begin{matrix}1 & 0 & 0 & 0 \\ 0 & {cos ( 2 θ )}^{2} + cos ( R ) {sin ( 2 θ )}^{2} & ( 1 - cos ( R ) ) sin ( 2 θ ) cos ( 2 θ ) & - sin ( R ) sin ( 2 θ ) \\ 0 & ( 1 - cos ( R ) ) sin ( 2 θ ) cos ( 2 θ ) & {sin ( 2 θ )}^{2} + cos ( R ) {sin ( 2 θ )}^{2} & sin ( R ) cos ( 2 θ ) \\ 0 & sin ( R ) sin ( 2 θ ) & - sin ( R ) cos ( 2 θ ) & cos ( R )\end{matrix} ] , \qquad Eq . ( 5 )$$

Performing the matrix muliplication of Eq. (1) using the components detailed in Eqs. (0)-(5) gives:

Tₛₘ(x, y)=0.00759612+(0.492404−0.492404 cos(R))cos(2θ)²+((−0.00876809 cos(R)+0.00876809)sin(2θ)−0.0863802 sin(R))cos(2θ), Eq. (6)

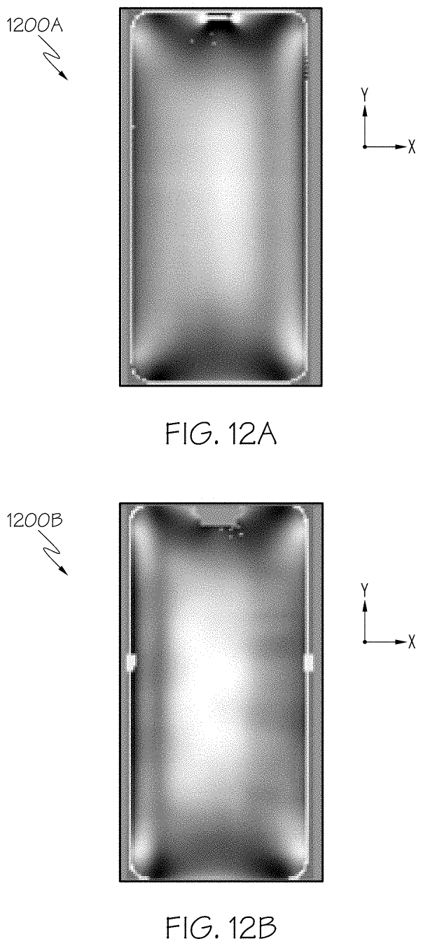

As an example, the transmission function given by Eq. (1) with components given by Eqs. (2)-(5) is used to create a transmission image of transmission intensities for the glass-based substrates, using their retardance measurements (e.g., as shown in FIGS. 10A, 10B, 11A and 11B). Using the calculated transmission values, calculated transmission images of the glass-based substrates are determined. FIG. 12A shows a calculated transmission image 1200A of the glass substrate having the retardance data of FIGS. 10A and 11A, and FIG. 12B shows a calculated transmission image 1200B of the glass substrate having the retardance data of FIGS. 10B and 11B. The transmission intensity variations, along with the defect of interest, are reproduced in the calculated images. It is noted that the only component with spatial variation of polarization properties is the measured glass substrate; the other components do not. Therefore, the band contrast thus calculated has the highest possible contrast. Advantageously, the calculated transmission maps lack some of the artifacts in the camera images that arise due to reflections and ambient light when utilizing an optical set-up. This makes is easier to “see” defects that are not very sharp. Another advantage is the quantification of intensity variations which can be used to quantify the defects using one or more defect metrics as described above. Results are not affected by ambient light level and reflections nor by spatial or wavelength variation of the polarization components of the instrument. A single set of retardance measurements of a given part can be used to calculate maps of transmitted intensity for different optical configurations and defect types by including the appropriate polarimetry formulas for each case in the software.

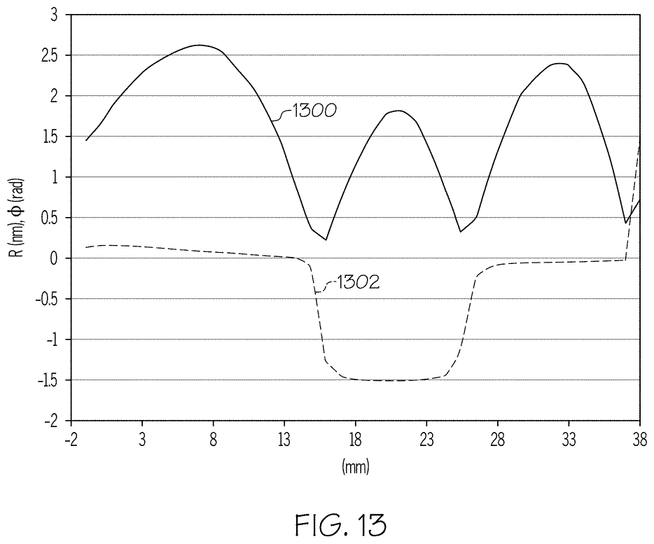

FIG. 13 graphically illustrates that the visible bands are created by correlated modulation of both retardance magnitude and orientation. Curve 1300 is the retardance magnitude (nm) and curve 1302 is the orientation (rad) over x-positions of a sample glass substrate. The gradients of retardance magnitude and sharp step-like changes in orientation show that the visibility metrics could be further refined by including human vision model for contrast sensitivity for cycles/degree.

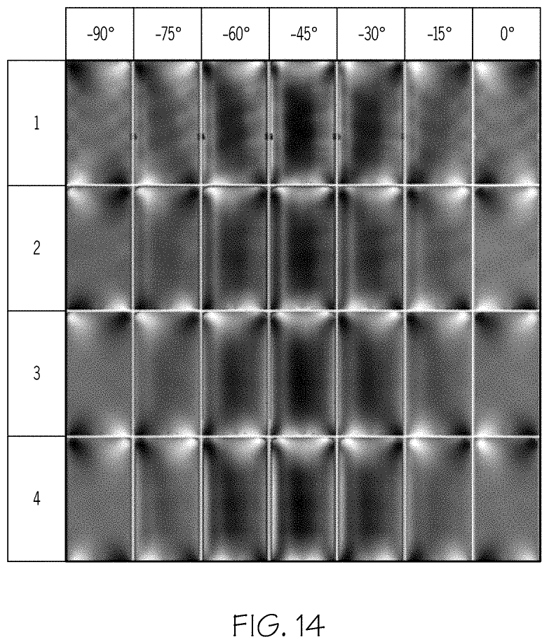

FIG. 14 depicts calculated transmission images of smartphones with cover glass samples viewed through polarizers at various angles from measured retardance and azimuth for four cover glass parts. In this case a similar but different optical configuration with the measured cover glass part retardance is used. For the sunglasses/cover glass/smartphone configuration Toone is calculated as:

Tₚₕₒₙₑ(R,θ,x,y)=[Analyzer_{ϕ}·CoverGlass(R,θ,x,y)·Stokesₚₕₒₙₑ], Eq. (7)

Analyzer_{φ} is the Mueller matrix for a linear polarizer at rotation angle φ with respect to the smartphone and cover glass:

$${Analyzer}_{ϕ} = ( \frac{1}{2} ) [ \begin{matrix}1 & cos ( 2 ϕ ) & sin ( 2 ϕ ) & 0 \\ cos ( 2 ϕ ) & {cos ( 2 ϕ )}^{2} & sin ( 2 ϕ ) cos ( 2 ϕ ) & 0 \\ sin ( 2 ϕ ) & sin ( 2 ϕ ) cos ( ϕ ) & {sin ( 2 ϕ )}^{2} & 0 \\ 0 & 0 & 0 & 0\end{matrix} ] , \qquad Eq . ( 8 )$$

CoverGlass(R,θ,x,y) is same as Eq. (5) above. Stokesoone is the spatial average of measured Stokes vector of smartphone of interest or an ideal polarizing component as appropriate. For the case of a particular smartphone of interest for the example cover glass parts of FIG. 14, it was found that an ideal circular polarizer gave excellent agreement with measurements and observations. Performing the matrix multiplication of Eq. (7) with the components described in this paragraph for the φ=−45° case gives:

Tₚₕₒₙₑ(R, θ, x, y)=½(1−sin(R)cos(2θ)), Eq. (9)

FIG. 14 shows that the band visibility very strongly depends on the sunglasses (analyzer) angle. Variation in principal stress axis orientation will give corresponding change to analyzer angle with maximum defect visibility. Embodiments of the present disclosure can determine the maximum defect visibility for any principal stress axis orientation in the cover glass with one set of measurements and not just one particular orientation like inspection methods with fixed configuration of optical components.

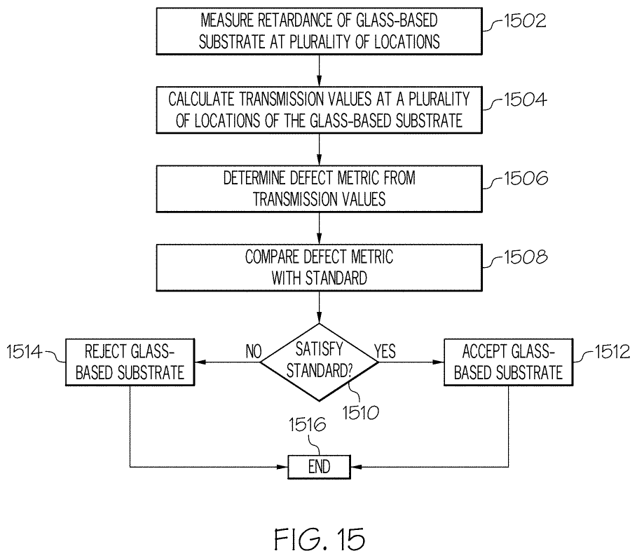

Referring now to FIG. 15, a flowchart illustrating an example method of evaluating a glass-based substrate for intensity variations, such as birefringence defects, using retardance data to calculate transmission values is illustrated. At block 1502, a glass-based substrate is measured for retardance at a plurality of (x, y) locations. The retardance measurements have a retardance magnitude component and an azimuth component. The retardance may be measured using a strain measurement system, for example. At block 1504, transmission values are determined by using the retardance magnitude and azimuth measured at block 1502 and a transmission function for a desired optical set-up. The process that follows is similar to the process illustrated by FIG. 9. Next, a defect metric (e.g., a defect metric as described above with respect to FIGS. 5, 6 and 7B) is determined at block 1506 using the transmission values calculated at block 1504.

At block 1508, the defect metric of the glass-based substrate is compared with one or more standards. If the defect metric satisfies the one or more standards at decision block 1510, the glass-based substrate is accepted at block 1512, and the process then ends at block 1516. If the birefringence characterization of the glass-based substrate does not satisfy the one or more metrics at decision block 1510, the glass-based substrate is rejected at block 1514, and the process then ends at block 1516. In some embodiments, a transmission image of the glass-based substrate is displayed on an electronic device.

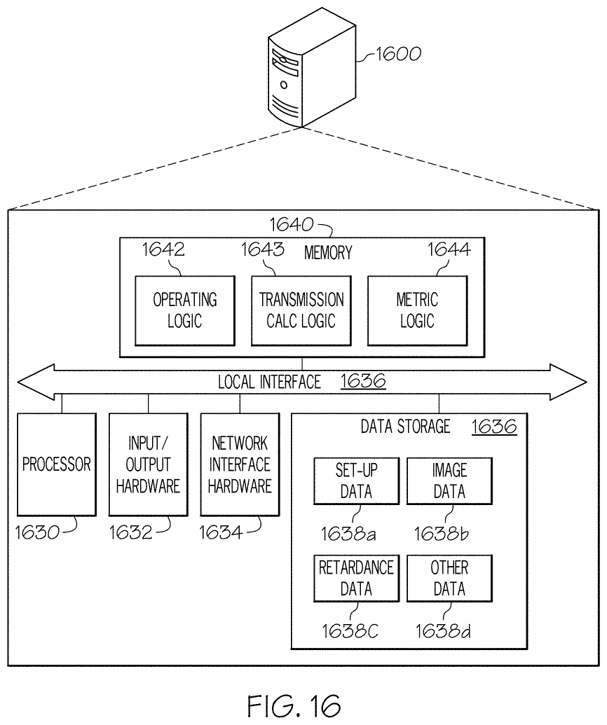

Referring now to FIG. 16, a system including an example computing device 1600 capable of performing the functionalities described herein is schematically illustrated.

While in some embodiments, the computing device 1600 may be configured as a general purpose computer with the requisite hardware, software, and/or firmware, in some embodiments, the computing device 1600 may be configured as a special purpose computer designed specifically for performing the functionality described herein.

The computing device may include a processor 1630, input/output hardware 1632, network interface hardware 1634, a data storage component 1636 (which stores set-up data 1638a , image data 1638b , retardance data 1638c , and other data 1638d), and a memory 1640. The memory 1640 may be configured as volatile and/or nonvolatile memory and, as such, may include random access memory (e.g., SRAM, DRAM, and/or other types of random access memory), flash memory, registers, compact discs (CDs), digital versatile discs (DVDs), and/or other types of non-transitory storage components. Additionally, the memory 1640 may be configured to store operating logic 1642, transmission calculation logic 1643 and metric logic 1644 (each of which may be embodied as a computer program, firmware, or hardware, as an example). A local interface 1646 is also included in FIG. 16 and may be implemented as a bus or other interface to facilitate communication among the components of the computing device 1600.

The processor 1630 may include any processing component configured to receive and execute computer-readable instructions (such as from the data storage component 1636 and/or memory 1640). The input/output hardware 1632 may include a monitor (i.e., an electronic display), keyboard, mouse, printer, camera, microphone, speaker, and/or other device for receiving, sending, and/or presenting data. Particularly, the input/output hardware 1632 may be configured to receive image data from one or more optical setup systems. The network interface hardware 1634 may include any wired or wireless networking hardware, such as a modem, LAN port, wireless fidelity (Wi-Fi) card, WiMax card, mobile communications hardware, and/or other hardware for communicating with other networks and/or devices. For example, the network interface hardware 1634 may be configured to receive image data.

It should be understood that the data storage component 1636 may reside local to and/or remote from the computing device 1600 and may be configured to store one or more pieces of data for access by the computing device 1600 and/or other components. It should also be understood that while set-up data 1638a , image data 1638b , retardance data 1638c , and other data 1638d are illustrated as being stored as part of data storage component 1636, they may be physically stored in multiple data storage components.

The data storage component 1636 stores set-up data 1638a , which in at least one embodiment includes information relating to optical set-ups as described above. Image data 1638b includes the data obtained from an optical setup, such as a camera, for example. Retardance data 1638c includes the retardance data of glass-based substrates that may be used to calculate transmission values. Other data 1638d may include miscellaneous data that is required to perform the functionalities of the embodiments described herein.

Operating logic 1642 may include the operating system of the computing device 1600 (e.g., Linux, Windows®, and MacOS®). The transmission calculation logic 1643 may be computer-readable instructions operable to receive as input the image data or retardance data and calculate one or more transmission curves. Metric logic 1644 may be computer-readable instructions configured to calculate one or more defect metrics from the one or more transmission curves, and compare the one or more defect metrics to one or more standards to either accept or reject glass-based substrates as described herein.

It should also be understood that the components illustrated in FIG. 16 are merely exemplary and are not intended to limit the scope of this disclosure. While the components of memory 1640 and data storage component 1636 are illustrated as separate components, one or more components may perform the functions of another component.

Additionally, while the components in FIG. 16 are illustrated as residing within the computing device 1600, this is merely an example. In some embodiments, one or more of the components may reside external to the computing device 1600. For example, image data 1638b may be stored on a separate computing device and accessed by the computing device 1600 over a network.

It should now be understood that embodiments described herein are directed to systems and methods for automated inspection of glass-based substrates for birefringence defects using a quantification defect metric. First and/or second derivative information is used to define local maximum points and nearby points of interest that are used to define the defect metric for defect quantification. The automated method removes the subjective human grading system currently used. Thus, glass-based substrates are more quickly and accurately evaluated.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A method of evaluating at least one glass-based substrate, the method comprising:
generating a transmission image of the at least one glass-based substrate;
determining at least one transmission curve along at least one line extending from a first edge of the transmission image to a second edge of the transmission image, wherein the transmission curve plots transmission values versus position along the at least one line;
determining a defect metric from the at least one transmission curve;
comparing the defect metric to at least one standard; and
rejecting the at least one glass-based substrate when the defect metric does not satisfy the at least one standard.

2. The method of claim 1, wherein:
the defect metric is defined by a defect height divided by a defect width;
the width is a distance between a first point of interest and a second point of interest based on the at least one transmission curve; and
the height is a distance between an extreme point and a line between the first point of interest and the second point of interest.

3. The method of claim 2, wherein:
the determining of the defect metric further comprises determining a first derivative of the at least one transmission curve;
the first point of interest is a first inflection point determined by a first position on the first derivative of the at least one transmission curve having a minimum value;
the second point of interest is a second inflection point determined by a second position on the first derivative of the at least one transmission curve having a maximum value; and
the first inflection point and the second inflection point are located on opposing sides of the extreme point.

4. The method of claim 2, wherein:
the determining of the defect metric further comprises determining a second derivative of the at least one transmission curve;
the first point of interest is a first inflection point determined by a first position where the second derivative of the at least one transmission curve crosses a zero axis;
the second point of interest is a second inflection point determined by a second position where the second derivative of the at least one transmission curve crosses the zero axis; and
the first inflection point and the second inflection point are located on opposing sides of the extreme point.

5. The method of claim 2, wherein:
the first point of interest is defined by a first maximum transmission value when the extreme point is a point of minimum transmission or a first minimum transmission value when the extreme point is a point of maximum transmission;
the second point of interest is defined by a second maximum transmission value when the extreme point is a point of minimum transmission or a second minimum transmission value when the extreme point is a point of maximum transmission; and
the first point of interest and the second point of interest are located on opposing sides of the extreme point.

6. The method of claim 1, wherein the generating of the transmission image further comprises propagating light from a backlight through a first linear polarizer, through the at least one glass-based substrate, through a quarter waveplate, and through a second linear polarizer.

7. The method of claim 1, wherein:
the transmission image is a calculated transmission image based at least in part on retardance data of the glass-based substrate; and
the calculated transmission image is calculated by:
measuring a retardance at a plurality of locations of the glass-based substrate to generate the retardance data; and
calculating, by a computing device, one or more transmission values at one or more locations of the plurality of locations of the glass-based substrate from the retardance data.

8. The method of claim 7, wherein:
a transmission value for each location of the plurality of locations is defined by:
Tₛₘ(x, y)=[Analyzerₛₘ·Waveplateₛₘ·Substrate(R, θ, x, y)·Stokesₛₘ][1] where:
Analyzerₛₘ is a Mueller matrix of an ideal linear polarizer with a given transmission axis value,
Waveplateₛₘ is a Mueller matrix of a retarder with a given magnitude and fast axis,
Substrate(R, θ, x, y) is a Mueller matrix for a retarder with measured retardance at location (x, y), wherein the retardance comprises a retardance magnitude R and a retardance azimuth θ, and
Stokesₛₘ is the Stokes vector for polarized light at a predetermined angle.

9. The method of claim 7, wherein a transmission value for each location of the plurality of locations is defined by:
Tₚₕₒₙₑ(x, y)=[Analyzer_{φ}·Substrate(R, θ, x, y)·Stokesₚₕₒₙₑ][1],where:
Analyzer_{φ} is a Mueller matrix of a linear polarizer with respect to an electronic device and the glass-based substrate,
Substrate(R, θ, x, y) is a Mueller matrix for a retarder with measured retardance at location (x, y), wherein the retardance comprises a retardance magnitude R and a retardance azimuth θ, and
Stokesₚₕₒₙₑ is the Stokes vector for polarized light at a predetermined angle.

10. The method of claim 1, wherein:
the at least one transmission curve comprises an average of a plurality of transmission curves; and
the plurality of transmission curves are determined along a plurality of lines extending from the first edge to the second edge of the transmission image.

11. A system for evaluating at least one glass-based substrate comprising:
one or more processors; and
a computer-readable medium storing computer-executable instructions that, when executed by the one or more processors, cause the one or more processors to:
generate a transmission image of the at least one glass-based substrate;
determine at least one transmission curve along at least one line extending from a first edge of the transmission image to a second edge of the transmission image, wherein the transmission curve plots transmission values versus position along the at least one line;
determine a defect metric from the at least one transmission curve; and
compare the defect metric to at least one standard.

12. The system of claim 11, wherein:
the defect metric is defined by a defect height divided by a defect width;
the width is a distance between a first point of interest and a second point of interest based on the at least one transmission curve; and
the height is a distance between an extreme point and a line between the first point of interest and the second point of interest.

13. The system of claim 12, wherein:
the defect metric is determined by determining a first derivative of the at least one transmission curve;
the first point of interest is a first inflection point determined by a first position on the first derivative of the at least one transmission curve having a minimum value;
the second point of interest is a second inflection point determined by a second position on the first derivative of the at least one transmission curve having a maximum value; and
the first inflection point and the second inflection point are located on opposing sides of the extreme point.

14. The system of claim 12, wherein:
the defect metric is determined by determining a second derivative of the at least one transmission curve;
the first point of interest is a first inflection point determined by a first position where the second derivative of the at least one transmission curve crosses a zero axis;
the second point of interest is a second inflection point determined by a second position where the second derivative of the at least one transmission curve crosses the zero axis; and
the first inflection point and the second inflection point are located on opposing sides of the extreme point.

15. The system of claim 12, wherein:
the first point of interest is defined by a first maximum transmission value when the extreme point is a point of minimum transmission or a first minimum transmission value when the extreme point is a point of maximum transmission;
the second point of interest is defined by a second maximum transmission value when the extreme point is a point of minimum transmission or a second minimum transmission value when the extreme point is a point of maximum transmission; and
the first point of interest and the second point of interest are located on opposing sides of the extreme point.

16. The system of claim 11, wherein the generating of the transmission image further comprises propagating light from a backlight through a first linear polarizer, through the at least one glass-based substrate, through a quarter waveplate, and through a second linear polarizer.

17. The system of claim 11, wherein:
the transmission image is a calculated transmission image based at least in part on retardance data of the glass-based substrate; and
the calculated transmission image is calculated by:
measuring a retardance at a plurality of locations of the glass-based substrate to generate the retardance data; and
calculating, by a computing device, one or more transmission values at one or more locations of the plurality of locations of the glass-based substrate from the retardance data.

18. The system of claim 17, wherein a transmission value for each location of the plurality of locations is defined by:
Tₛₘ(x, y)=[Analyzerₛₘ·Waveplateₛₘ·Substrate(R, θ, x, y)·Stokesₛₘ][1] where:
Analyzerₛₘ is a Mueller matrix of an ideal linear polarizer with a given transmission axis value,
Waveplateₛₘ is a Mueller matrix of a retarder with a given magnitude and fast axis,
Substrate(R, θ, x, y) is a Mueller matrix for a retarder with measured retardance at location (x, y), wherein the retardance comprises a retardance magnitude R and a retardance azimuth θ, and
Stokesₛₘ is the Stokes vector for polarized light at a predetermined angle.

19. The system of claim 11, wherein a transmission value for each location of the plurality of locations is defined by:
Tₚₕₒₙₑ(x, y)=[Analyzer_{φ}·Substrate(R, θ, x, y)·Stokesₚₕₒₙₑ][1], where:
Analyzer_{φ} is a Mueller matrix of a linear polarizer with respect to an electronic device and the glass-based substrate,
Substrate(R, θ, x, y) is a Mueller matrix for a retarder with measured retardance at location (x, y), wherein the retardance comprises a retardance magnitude R and a retardance azimuth θ, and
Stokesₚₕₒₙₑ is the Stokes vector for polarized light at a predetermined angle.

20. The system of claim 11, wherein:
the at least one transmission curve comprises an average of a plurality of transmission curves; and
the plurality of transmission curves are determined along a plurality of lines extending from the first edge to the second edge of the transmission image.
